(19) United States
(12) Patent Application Publication
(10) Pub. No.: US 2018/0199287 A1
(43) Pub. Date: Jul. 12, 2018

(54) METHOD AND USER EQUIPMENT FOR RECEIVING DOWNLINK SIGNALS

(71) Applicant: LG ELECTRONICS INC., Seoul (KR)

(72) Inventors: Sunyoung LEE, Seoul (KR); Seungjune YI, Seoul (KR)

(73) Assignee: LG ELECTRONICS INC., Seoul (KR)

(21) Appl. No.: 15/862,571

(22) Filed: Jan. 4, 2018

Related U.S. Application Data
(60) Provisional application No. 62/443,027, filed on Jan. 6, 2017.

(51) Int. Cl. H04W 52/02; H04W 72/04

(52) U.S. Cl. CPC H04W 52/0216; H04W 4/70; H04W 72/0446; H04W 72/042

(57) ABSTRACT

A user equipment configures multiple physical downlinnk control channel (PDCCH) reception opportunities per PDCCH subframe. The UE monitors a PDCCH in each PDCCH reception opportunity if a counter does not reach a maximum value for the counter. The UE increases the counter by one every PDCCH reception opportunity, wherein the UE increase the counter by more than one in a PDCCH subframe.

### CROSS-REFERENCE TO RELATED APPLICATIONS

Pursuant to 35 U.S.C. § 119(e), this application claims the benefit of U.S. Provisional Patent Application No. 62/443,027, filed on Jan. 6, 2017, the contents of which are hereby incorporated by reference herein in its entirety.

### TECHNICAL FIELD

The present invention relates to a wireless communication system, and more particularly, to a method for receiving downlink signals and an apparatus therefor.

### BACKGROUND ART

As an example of a mobile communication system to which the present invention is applicable, a 3rd Generation Partnership Project Long Term Evolution (hereinafter, referred to as LTE) communication system is described in brief

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

As more and more communication devices demand larger communication capacity, there is a need for improved mobile broadband communication compared to existing RAT. Also, massive machine type communication (MTC), which provides various services by connecting many devices and objects, is one of the major issues to be considered in the next generation communication. In addition, a communication system design considering a service/UE sensitive to reliability and latency is being discussed. The introduction of next-generation RAT, which takes into account such advanced mobile broadband communication, massive MTC (mMCT), and ultra-reliable and low latency communication (URLLC), is being discussed.

### Technical Problem

Due to introduction of new radio communication technology, the number of user equipments (UEs) to which a BS should provide a service in a prescribed resource region increases and the amount of data and control information that the BS should transmit to the UEs increases. Since the amount of resources available to the BS for communication with the UE(s) is limited, a new method in which the BS efficiently receives/transmits uplink/downlink data and/or uplink/downlink control information using the limited radio resources is needed.

With development of technologies, overcoming delay or latency has become an important challenge. Applications whose performance critically depends on delay/latency are increasing. Accordingly, a method to reduce delay/latency compared to the legacy system is demanded.

Also, with development of smart devices, a new scheme for efficiently transmitting/receiving a small amount of data or efficiently transmitting/receiving data occurring at a low frequency is required.

Also, a method for transmitting/receiving signals effectively in a system supporting new radio access technology is required.

The technical objects that can be achieved through the present invention are not limited to what has been particularly described hereinabove and other technical objects not described herein will be more clearly understood by persons skilled in the art from the following detailed description.

### SUMMARY

In an aspect of the present invention, provided herein is a method of receiving, by a user equipment (UE), downlink signals. The method comprises: configuring, by the UE, multiple physical downlink control channel (PDCCH) reception opportunities per PDCCH subframe; monitoring, by the UE, a PDCCH in each PDCCH reception opportunity if a counter does not reach a maximum value for the counter; and increasing, by the UE, the counter by one every PDCCH reception opportunity. The counter may increase by more than one in a PDCCH subframe.

In another aspect of the present invention, provided herein is a user equipment for receiving downlink signals. The UE comprises: a radio frequency (RF) unit, and a processor configured to control the RF unit. The processor may be configured to: configure multiple physical downlink control channel (PDCCH) reception opportunities per PDCCH subframe; monitor a PDCCH in each PDCCH reception opportunity if a counter does not reach a maximum value for the counter; and increase the counter by one every PDCCH reception opportunity. The processor may be configured to increase the counter by more than one in a PDCCH subframe.

In each aspect of the present invention, the number of multiple PDCCH reception opportunities configured per PDCCH subframe may be depending on a transmission time interval (TTI) duration configured at the UE.

In each aspect of the present invention, the counter may be a drx retransmission timer, or a drx UL retransmission timer.

In each aspect of the present invention, the UE may receive information indicating the maximum value for the counter.

In each aspect of the present invention, the maximum value may be a value in number of PDCCH reception opportunities.

The above technical solutions are merely some parts of the embodiments of the present invention and various embodiments into which the technical features of the present invention are incorporated can be derived and understood by persons skilled in the art from the following detailed description of the present invention.

According to the present invention, radio communication signals can be efficiently transmitted/received. Therefore, overall throughput of a radio communication system can be improved.

According to one embodiment of the present invention, a low cost/complexity UE can perform communication with a base station (BS) at low cost while maintaining compatibility with a legacy system.

According to one embodiment of the present invention, the UE can be implemented at low cost/complexity.

According to one embodiment of the present invention, the UE and the BS can perform communication with each other at a narrowband.

According to an embodiment of the present invention, delay/latency occurring during communication between a user equipment and a BS may be reduced.

Also, it is possible to efficiently transmit/receive a small amount of data for smart devices, or efficiently transmit/receive data occurring at a low frequency.

Also, signals in a new radio access technology system can be transmitted/received effectively.

According to an embodiment of the present invention, a small amount of data may be efficiently transmitted/received.

It will be appreciated by persons skilled in the art that that the effects that can be achieved through the present invention are not limited to what has been particularly described hereinabove and other advantages of the present invention will be more clearly understood from the following detailed description.

### BRIEF DESCRIPTION OF THE DRAWING

The accompanying drawings, which are included to provide a further understanding of the invention, illustrate embodiments of the invention and together with the description serve to explain the principle of the invention.

FIG. 1 is a view schematically illustrating a network structure of an E-UMTS as an exemplary radio communication system.

FIG. 2 is a block diagram illustrating network structure of an evolved universal mobile telecommunication system (E-UMTS).

FIG. 3 is a block diagram depicting architecture of a typical E-UTRAN and a typical EPC.

FIG. 4 is a diagram showing a control plane and a user plane of a radio interface protocol between a UE and an E-UTRAN based on a 3GPP radio access network standard.

FIG. 5 is a view showing an example of a physical channel structure used in an E-UMTS system.

FIG. 6 is a diagram for medium access control (MAC) structure overview in a UE side.

FIG. 7 is a diagram showing a concept of discontinuous reception (DRX).

FIG. 8 is a diagram showing a method for a DRX operation in the legacy LTE/LTE-A system.

FIG. 9 illustrates methods for counting DRX time according to the present invention.

FIG. 10 is a block diagram illustrating elements of a transmitting device 100 and a receiving device 200 for implementing the present invention.

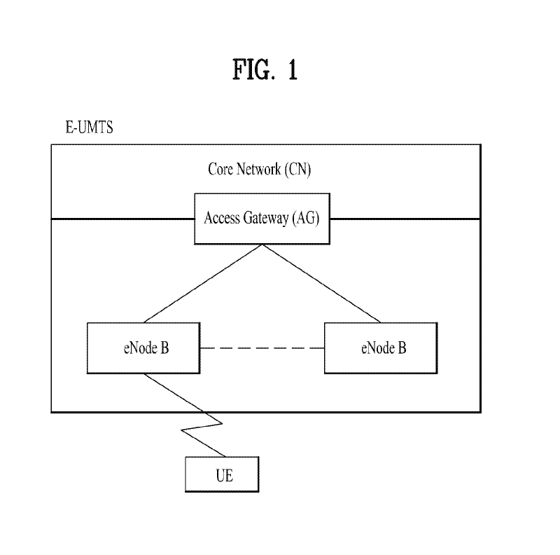

### DETAILED DESCRIPTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to a 3GPP LTE/LTE-A system, aspects of the present invention that are not specific to 3GPP LTE/LTE-A are applicable to other mobile communication systems.

For example, the present invention is applicable to contention based communication such as Wi-Fi as well as non-contention based communication as in the 3GPP LTE/LTE-A system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, the term “assume” may mean that a subject to transmit a channel transmits the channel in accordance with the corresponding “assumption.” This may also mean that a subject to receive the channel receives or decodes the channel in a form conforming to the “assumption,” on the assumption that the channel has been transmitted according to the “assumption.”

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. Especially, a BS of the UMTS is referred to as a NB, a BS of the EPC/LTE is referred to as an eNB, and a BS of the new radio (NR) system is referred to as a gNB. For convenience of description, in describing the present invention, a BS will be referred to as an eNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port or a virtual antenna.

In the present invention, a cell refers to a prescribed geographical area to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell.

Meanwhile, a 3GPP LTE/LTE-A system uses the concept of a cell in order to manage radio resources and a cell associated with the radio resources is distinguished from a cell of a geographic region.

A “cell” of a geographic region may be understood as coverage within which a node can provide service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of a radio resource used by the node. Accordingly, the term “cell” may be used to indicate service coverage of the node sometimes, a radio resource at other times, or a range that a signal using a radio resource can reach with valid strength at other times.

Meanwhile, the 3GPP LTE-A standard uses the concept of a cell to manage radio resources. The “cell” associated with the radio resources is defined by combination of downlink resources and uplink resources, that is, combination of DL component carrier (CC) and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency means a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the S cell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

In the present invention, “PDCCH” refers to a PDCCH, an EPDCCH (in subframes when configured), a MTC PDCCH (MPDCCH), for an RN with R-PDCCH configured and not suspended, to the R-PDCCH or, for NB-IoT to the narrowband PDCCH (NPDCCH).

In the present invention, monitoring a channel implies attempting to decode the channel. For example, monitoring a PDCCH implies attempting to decode PDCCH(s) (or PDCCH candidates).

In the present invention, for dual connectivity operation the term “special Cell” refers to the PCell of the master cell group (MCG) or the PSCell of the secondary cell group (SCG), otherwise the term Special Cell refers to the PCell. The MCG is a group of serving cells associated with a master eNB (MeNB) which terminates at least S1-MME, and the SCG is a group of serving cells associated with a secondary eNB (SeNB) that is providing additional radio resources for the UE but is not the MeNB. The SCG is comprised of a primary SCell (PSCell) and optionally one or more SCells. In dual connectivity, two MAC entities are configured in the UE: one for the MCG and one for the SCG. Each MAC entity is configured by RRC with a serving cell supporting PUCCH transmission and contention based Random Access. In this specification, the term SpCell refers to such cell, whereas the term SCell refers to other serving cells. The term SpCell either refers to the PCell of the MCG or the PSCell of the SCG depending on if the MAC entity is associated to the MCG or the SCG, respectively.

In the present invention, “C-RNTI” refers to a cell RNTI, “SI-RNTI” refers to a system information RNTI, “P-RNTI” refers to a paging RNTI, “RA-RNTI” refers to a random access RNTI, “SC-RNTI” refers to a single cell RNTI″, “SL-RNTI” refers to a sidelink RNTI, and “SPS C-RNTI” refers to a semi-persistent scheduling C-RNTI.

For terms and technologies which are not specifically described among the terms of and technologies employed in this specification, 3GPP LTE/LTE-A standard documents, for example, 3GPP TS 36.211, 3GPP TS 36.212, 3GPP TS 36.213, 3GPP TS 36.300, 3GPP TS 36.321, 3GPP TS 36.322, 3GPP TS 36.323 and 3GPP TS 36.331 may be referenced.

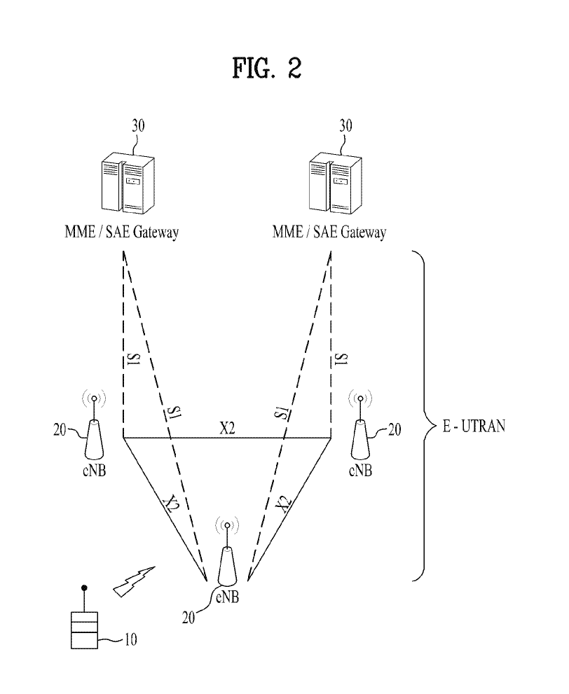

FIG. 2 is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNB 20 to UE 10, and “uplink” refers to communication from the UE to an eNB.

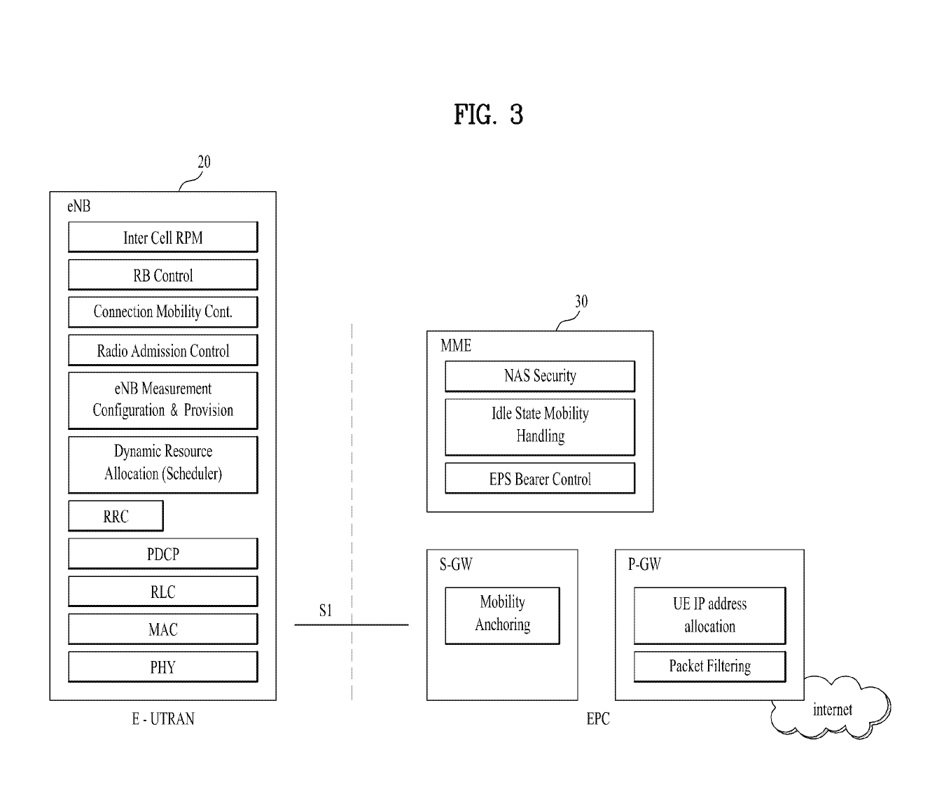

FIG. 3 is a block diagram depicting architecture of a typical E-UTRAN and a typical EPC.

As illustrated in FIG. 3, an eNB 20 provides end points of a user plane and a control plane to the UE 10. MME/SAE gateway 30 provides an end point of a session and mobility management function for UE 10. The eNB and MME/SAE gateway may be connected via an S1 interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including NAS signaling to eNBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, roaming, authentication, bearer management functions including dedicated bearer establishment, support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

As illustrated, eNB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

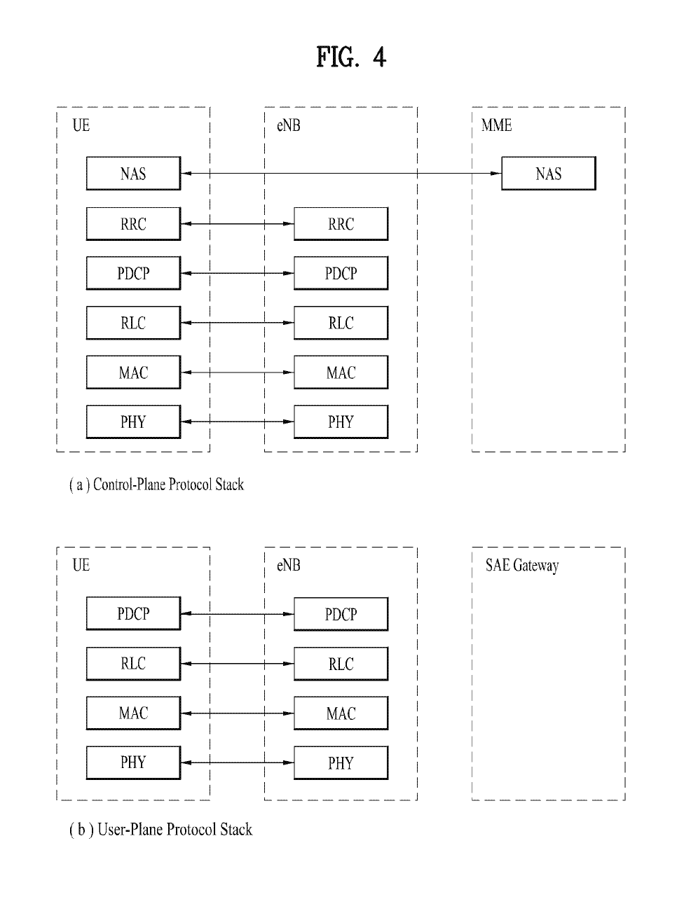

FIG. 4 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

Layer 1 (i.e. L1) of the LTE/LTE-A system is corresponding to a physical layer. A physical (PHY) layer of a first layer (Layer 1 or L1) provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

Layer 2 (i.e. L2) of the LTE/LTE-A system is split into the following sublayers: Medium Access Control (MAC), Radio Link Control (RLC) and Packet Data Convergence Protocol (PDCP). The MAC layer of a second layer (Layer 2 or L2) provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

Layer 3 (i.e. L3) of the LTE/LTE-A system includes the following sublayers: Radio Resource Control (RRC) and Non Access Stratum (NAS). A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other. The non-access stratum (NAS) layer positioned over the RRC layer performs functions such as session management and mobility management.

Radio bearers are roughly classified into (user) data radio bearers (DRBs) and signaling radio bearers (SRBs). SRBs are defined as radio bearers (RBs) that are used only for the transmission of RRC and NAS messages.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

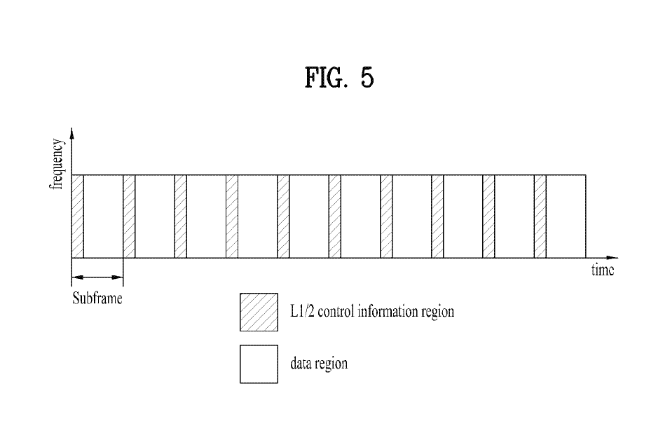

FIG. 5 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. The PDCCH carries scheduling assignments and other control information. In FIG. 5, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information.

A time interval in which one subframe is transmitted is defined as a transmission time interval (TTI). Time resources may be distinguished by a radio frame number (or radio frame index), a subframe number (or subframe index), a slot number (or slot index), and the like. TTI refers to an interval during which data may be scheduled. For example, in the current LTE/LTE-A system, an opportunity of transmission of an UL grant or a DL grant is present every 1 ms, and the UL/DL grant opportunity does not exists several times in less than 1 ms. Therefore, the TTI in the legacy LTE/LTE-A system is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information. In the present invention, a PDCCH addressed to a certain RNTI means that the PDCCH is CRC-masked with the certain RNTI. A UE may attempt to decode a PDCCH using the certain RNTI if the UE is monitoring a PDCCH addressed to the certain RNTI.

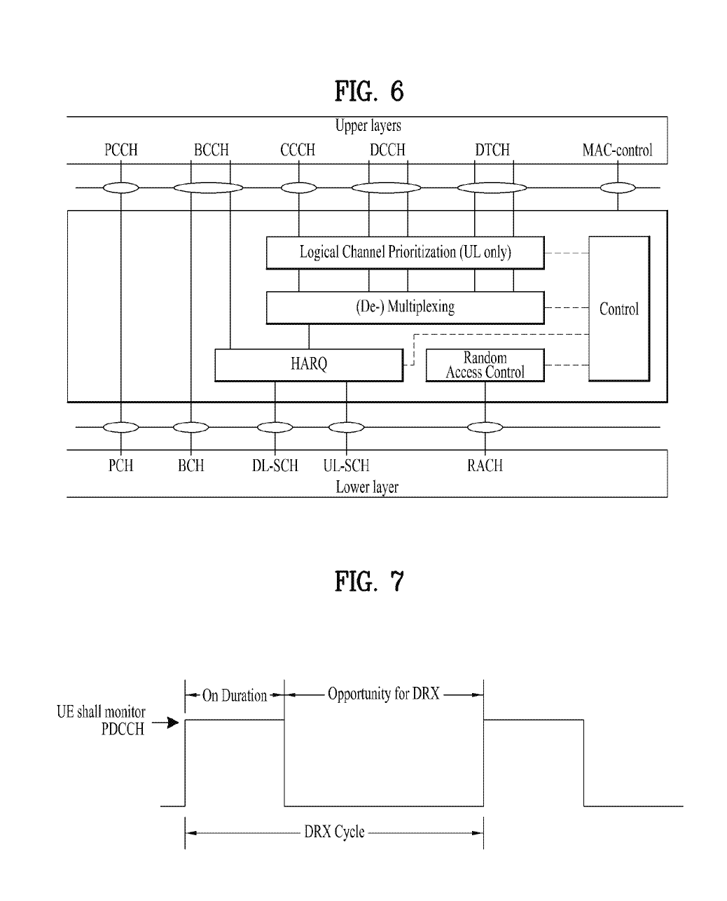

FIG. 6 is a diagram for medium access control (MAC) structure overview in a UE side.

The MAC layer supports the following functions: mapping between logical channels and transport channels; multiplexing of MAC SDUs from one or different logical channels onto transport blocks (TB) to be delivered to the physical layer on transport channels; demultiplexing of MAC SDUs from one or different logical channels from transport blocks (TB) delivered from the physical layer on transport channels; scheduling information reporting (e.g. scheduling request, buffer status reporting); error correction through HARQ; priority handling between UEs by means of dynamic scheduling; priority handling between logical channels of one MAC entity; Logical Channel Prioritization (LCP); transport format selection; and radio resource selection for sidelink (SL).

FIG. 7 is a diagram showing a concept of discontinuous reception (DRX).

In the LTE/LTE-A system, DRX is performed by a UE to reduce its power consumption due to continuous monitoring of PDCCH, where monitoring implies attempting to decode each of the PDCCHs in a set of PDCCH candidates. Without DRX, the UE has to be awake all the time in order to decode downlink data, as the data in the downlink may arrive at any time. This has serious impact on the power consumption of the UE. The MAC entity may be configured by RRC with a DRX functionality that controls the UE's PDCCH monitoring activity. When in RRC_CONNECTED, if DRX is configured, the MAC entity is allowed to monitor the PDCCH discontinuously using the DRX operation; otherwise the MAC entity monitors the PDCCH continuously. Referring to FIG. 7, if DRX is configured for a UE in RRC_CONNECTED state, the UE attempts to receive a downlink channel, PDCCH, that is, performs PDCCH monitoring only during a predetermined time period, while the UE does not perform PDCCH monitoring during the remaining time period. A time period during which the UE should monitor a PDCCH is referred to as “On Duration”. In other words, “On Duration” is a duration in downlink subframes that the UE waits for, after waking up from DRX, to receive PDCCH(s). If the UE successfully decodes a PDCCH, the UE stays awake and starts the inactivity timer (drx-InactivityTimer). The inactive timer is a duration in downlink subframes that the UE waits to successfully decode a PDCCH, from the last successful decoding of a PDCCH, failing which it re-enters DRX. The UE shall restart the inactivity timer following a single successful decoding of a PDCCH for a first transmission only (i.e. not for retransmissions). One On Duration is defined per DRX cycle. That is, a DRX cycle specifies the periodic repetition of the On Duration followed by a possible period of inactivity as shown in FIG. 7.

The UE always monitors a PDCCH during the On Duration in one DRX cycle and a DRX cycle determines a period in which an On Duration is set. DRX cycles are classified into a long DRX cycle and a short DRX cycle according to the periods of the DRX cycles. The long DRX cycle may minimize the battery consumption of a UE, whereas the short DRX cycle may minimize a data transmission delay.

When the UE receives a PDCCH during the On Duration in a DRX cycle, an additional transmission or a retransmission may take place during a time period other than the On Duration. Therefore, the UE should monitor a PDCCH during a time period other than the On Duration. That is, the UE should perform PDCCH monitoring during a time period over which an inactivity managing timer, drx-InactivityTimer or a retransmission managing timer, drx-RetransmissionTimer as well as an On Duration managing timer, onDurationTimer is running.

RRC controls DRX operation by configuring the timers onDurationTimer, drx-InactivityTimer, drx-Retransmission Timer (one per DL HARQ process except for the broadcast process), drx-ULRetransmissionTimer (one per asynchronous UL HARQ process), the longDRX-Cycle, the value of the drxStartOffset and optionally the drxShortCycleTimer and shortDRX-Cycle. An eNB provides a UE with DRX configuration information including these parameters through an RRC signaling. UE receives DRX configuration information. A DL HARQ RTT timer per DL HARQ process (except for the broadcast process) and UL HARQ RTT timer per asynchronous UL HARQ process is also defined. onDurationTimer specifies the number of consecutive PDCCH-subframe(s) at the beginning of a DRX Cycle. drx-InactivityTimer specifies the number of consecutive PDCCH-subframe(s) after the subframe in which a PDCCH indicates an initial UL, DL or SL user data transmission for this MAC entity. drx-Retransmission Timer specifies the maximum number of consecutive PDCCH-subframe(s) until a DL retransmission is received. drx-ULRetransmissionTimer specifies the maximum number of consecutive PDCCH-subframe(s) until a grant for UL retransmission is received. drxStartOffset specifies the subframe where the DRX Cycle starts. drxShortCycleTimer specifies the number of consecutive subframe(s) the MAC entity shall follow the Short DRX cycle. A DL HARQ RTT timer specifies the minimum amount of subframe(s) before a DL HARQ retransmission is expected by the MAC entity. UL HARQ RTT timer specifies the minimum amount of subframe(s) before a UL HARQ retransmission grant is expected by the MAC entity.

For each serving cell, in case of FDD configuration on the serving cell which carries the HARQ feedback for this serving cell the DL HARQ RTT timer is set to 8 subframes. For each serving cell, in case of TDD configuration on the serving cell which carries the HARQ feedback for this serving cell the DL HARQ RTT timer is set to k+4 subframes, where k is the interval between the downlink transmission and the transmission of associated HARQ feedback (see 3GPP TS 36.213). For bandwidth reduced low complexity (BL) UEs and UEs in enhanced coverage, DL HARQ RTT timer corresponds to 7+N where N is the used PUCCH repetition factor, where only valid (configured) UL subframes as configured by upper layers in fddUplinkSubframeBitmapLC are counted. In case of TDD, HARQ RTT timer corresponds to 3+k+N, where k is the interval between the last repetition of downlink transmission and the first repetition of the transmission of associated HARQ feedback, and N is the used PUCCH repetition factor, where only valid UL subframes are counted (see 3GPP TS 36.213). For NB-IoT the HARQ RTT timer is set to k+3+N+deltaPDCCH subframes, where k is the interval between the last subframe of the downlink transmission and the first subframe of the associated HARQ feedback transmission and N is the transmission duration in subframes of the associated HARQ feedback, and deltaPDCCH is the interval from the last subframe of the associated HARQ feedback transmission plus 3 subframes to the first subframe of the next PDCCH occasion. Except for NB-IoT, UL HARQ RTT timer length is set for 4 subframes for FDD, and set to k_{ULHARQRTT} subframes for TDD, where k_{ULHARQRTT} equals to the k_{PHICH} value indicated in a table showing k_{PHICH} for TDD (see 3GPP TS 36.213). For NB-IoT, the UL HARQ RTT timer length is set to 4+deltaPDCCH subframes, where deltaPDCCH is the interval from the last subframe of the PUSCH transmission plus 4 subframes to the first subframe of the next PDCCH occasion.

The value of each of the timers is defined as the number of subframes. The number of subframes is counted until the value of a timer is reached. If the value of the timer is satisfied, the timer expires. A timer is running once it is started, until it is stopped or until it expires; otherwise it is not running. A timer can be started if it is not running or restarted if it is running. A timer is always started or restarted from its initial value.

Additionally, the UE should perform PDCCH monitoring during random access or when the UE transmits a scheduling request and attempts to receive a UL grant.

A time period during which a UE should perform PDCCH monitoring is referred to as an Active Time. The Active Time is a total duration that the UE is awake. This includes the “On Duration” of the DRX cycle, the time UE is performing continuous reception while the inactivity timer has not expired and the time UE is performing continuous reception while waiting for a DL retransmission after one HARQ RTT or, for asynchronous UL HARQ operation, for a UL retransmission grant after one UL HARQ RTT. Based on the above the minimum active time is of length equal to On Duration, and the maximum is undefined (infinite). The Active Time includes On Duration during which a PDCCH is monitored periodically and a time interval during which a PDCCH is monitored upon generation of an event.

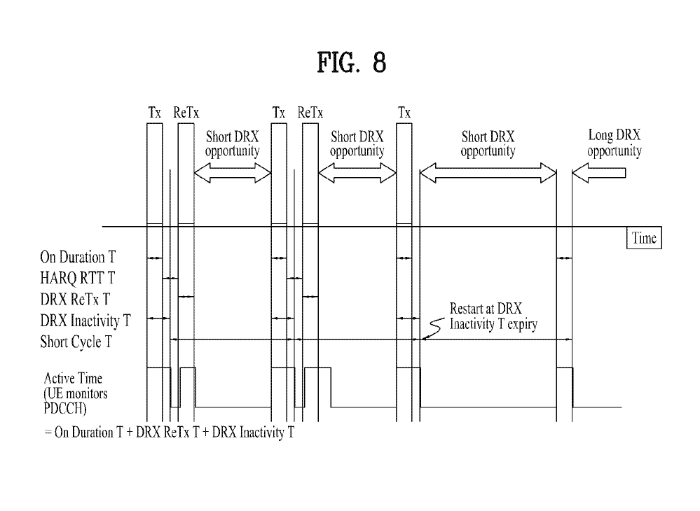

FIG. 8 is a diagram showing a method for a DRX operation in the legacy LTE/LTE-A system.

When a DRX cycle is configured, the Active Time includes the time while:

onDurationTimer or drx-InactivityTimer or drx-Retransmission Timer or drx-ULRetransmissionTimer or mac-ContentionResolutionTimer is running; or

a Scheduling Request is sent on PUCCH and is pending; or

an uplink grant for a pending HARQ retransmission can occur and there is data in the corresponding HARQ buffer for synchronous HARQ process; or

a PDCCH indicating a new transmission addressed to the C-RNTI of the MAC entity has not been received after successful reception of a Random Access Response for the preamble not selected by the MAC entity.

When DRX is configured, for each subframe, the MAC entity:

if a DL HARQ RTT timer expires in this subframe and the data of the corresponding HARQ process was not successfully decoded:

start the drx-RetransmissionTimer for the corresponding HARQ process.

if an UL HARQ RTT timer expires in this subframe:

start the drx-ULRetransmissionTimer for the corresponding HARQ process.

if a DRX Command MAC control element or a Long DRX Command MAC control element is received:

stop onDurationTimer;

stop drx-InactivityTimer.

if drx-InactivityTimer expires or a DRX Command MAC control element is received in this subframe:

if the Short DRX cycle is configured:

start or restart drxShortCycleTimer;

use the Short DRX Cycle.

else:

use the Long DRX cycle.

if drxShortCycleTimer expires in this subframe:

use the Long DRX cycle.

if a Long DRX Command MAC control element is received:

stop drxShortCycleTimer;

use the Long DRX cycle.

If the Short DRX Cycle is used and {(SFN*10)+subframe number} modulo (shortDRX-Cycle)=(drxStartOffset) modulo (shortDRX-Cycle); or

if the Long DRX Cycle is used and {(SFN*10)+subframe number} modulo (longDRX-Cycle)=drxStartOffset:

if NB-IoT:

if neither HARQ RTT Timer nor UL HARQ RTT Timer is running, start onDurationTimer.

else:

start onDurationTimer.

during the Active Time, for a PDCCH-subframe, if the subframe is not required for uplink transmission for half-duplex FDD UE operation, and if the subframe is not a half-duplex guard subframe (see 3GPP TS 36.211) and if the subframe is not part of a configured measurement gap and if the subframe is not part of a configured Sidelink Discovery Gap for Reception, and for NB-IoT if the subframe is not required for uplink transmission or downlink reception other than on PDCCH; or

during the Active Time, for a subframe other than a PDCCH-subframe and for a UE capable of simultaneous reception and transmission in the aggregated cells, if the subframe is a downlink subframe indicated by a valid eIMTA L1 signalling for at least one serving cell not configured with schedulingCellId (see 3GPP TS 36.331) and if the subframe is not part of a configured measurement gap and if the subframe is not part of a configured Sidelink Discovery Gap for Reception; or

during the Active Time, for a subframe other than a PDCCH-subframe and for a UE not capable of simultaneous reception and transmission in the aggregated cells, if the subframe is a downlink subframe indicated by a valid eIMTA L1signalling for the SpCell and if the subframe is not part of a configured measurement gap and if the subframe is not part of a configured Sidelink Discovery Gap for Reception:

monitor the PDCCH;

if the PDCCH indicates a DL transmission or if a DL assignment has been configured for this subframe:

if the UE is an NB-IoT UE, a BL UE or a UE in enhanced coverage:

start the HARQ RTT Timer for the corresponding HARQ process in the subframe containing the last repetition of the corresponding PDSCH reception;

else:

start the DL HARQ RTT timer for the corresponding HARQ process;

stop the drx-Retransmission Timer for the corresponding HARQ process.

if the PDCCH indicates an UL transmission for an asynchronous HARQ process:

start the UL HARQ RTT Timer for the corresponding HARQ process in the subframe containing the last repetition of the corresponding PUSCH transmission;

except for NB-IoT, stop the drx-ULRetransmissionTimer for the corresponding HARQ process.

if the PDCCH indicates a new transmission (DL, UL or SL):

except for NB-IoT, start or restart drx-InactivityTimer.

if the PDCCH indicates a transmission (DL, UL) for a NB-IoT UE:

stop drx-InactivityTimer, drx-ULRetransmissionTimer and onDurationTimer.

In case of downlink spatial multiplexing, if a transport block (TB) is received while the HARQ RTT Timer is running and the previous transmission of the same TB was received at least N subframes before the current subframe (where N corresponds to the HARQ RTT Timer), the MAC entity should process it and restart the HARQ RTT Timer.

When a DRX timer is set to a value of X, and n denotes the subframe in which the related event is triggered according to the above description, the intended behaviours of each DRX timer are presented in Table 1 below:

TABLE 1

| | Intended UE behaviour |
|---|---|
| DRX Timers | ([x, y] means including subframe x and y) |
| drx-InactivityTimer | The MAC entity monitors PDCCH in PDCCH-subframes |
| | during the subframes [n + 1, n + m]. |
| | The MAC entity starts or restarts drxShortCycleTimer, and |
| | uses Short DRX Cycle in the subframe n + m + 1, if configured. |
| drx-InactivityTimerSCPTM | The MAC entity monitors PDCCH in PDCCH-subframes |
| | during the subframes [n + 1, n + m]. |
| mac- | The MAC entity monitors PDCCH in PDCCH-subframes |
| ContentionResolutionTimer | during the subframes [n + 1, n + X]. |
| or mac- | |
| ContentionResolutionTimer | |
| for the corresponding | |
| enhanced coverage level, if | |
| it exists | |
| drx-RetransmissionTimer or | The MAC entity monitors PDCCH in PDCCH-subframes |
| drx-ULRetransmissionTimer | during the subframes [n, n + m − 1]. |
| onDurationTimer or onDuration | The MAC entity monitors PDCCH in PDCCH-subframes |
| TimerSCPTM | during the subframes [n, n + m − 1]. |
| drxShortCycleTimer | The MAC entity uses the Short DRX Cycle during the |
| | subframes [n, n + X − 1]. |
| | The MAC entity starts to use the Long DRX Cycle in the |
| | subframe n + X. |
| HARQ RTT Timer | The MAC entity starts drx-RetransmissionTimer in the |
| | subframe n + X, if needed. |
| UL HARQ RTT Timer | The MAC entity starts drx- |
| | ULRetransmissionTimer in the subframe n + X, if needed. |

NOTE:
For FDD, m is equal to X; for TDD, m is equal to the minimum number of subframes so that X PDCCH-subframes are included during the subframes [x, y].
NOTE:
A MAC entity configured with eIMTA monitors PDCCH in some subframe(s) in addition to PDCCH-subframes.

In the above description, PDCCH-subframe refers to a subframe with PDCCH. For a MAC entity not configured with any TDD serving cell(s), this represents any subframe; for a MAC entity configured with at least one TDD serving cell, if a MAC entity is capable of simultaneous reception and transmission in the aggregated cells, this represents the union over all serving cells of downlink subframes and subframes including DwPTS of the TDD UL/DL configuration indicated by tdd-Config (see 3GPP TS 36.331) parameter provided through an RRC signaling, except serving cells that are configured with schedulingCellId parameter provided through an RRC signaling; otherwise, this represents the subframes where the SpCell is configured with a downlink subframe or a subframe including DwPTS of the TDD UL/DL configuration indicated by tdd-Config.

There is one HARQ entity at the MAC entity for each serving cell which maintains a number of parallel HARQ processes. Each HARQ process is associated with a HARQ process identifier. The HARQ entity directs HARQ information and associated transport blocks (TBs) received on the DL-SCH to the corresponding HARQ processes. In the legacy LTE/LTE-A system, there are a maximum of 8 DL HARQ processes per serving cell for FDD. In asynchronous HARQ operation, HARQ process is associated with TTI based on the received UL grant. Each asynchronous HARQ process is associated with a HARQ process identifier. HARQ feedback is not applicable for asynchronous UL HARQ. In the legacy LTE/LTE-A system, there are a maximum of 8 or 16 UL HARQ processes per serving cell for FDD.

A fully mobile and connected society is expected in the near future, which will be characterized by a tremendous amount of growth in connectivity, traffic volume and a much broader range of usage scenarios. Some typical trends include explosive growth of data traffic, great increase of connected devices and continuous emergence of new services. Besides the market requirements, the mobile communication society itself also requires a sustainable development of the eco-system, which produces the needs to further improve system efficiencies, such as spectrum efficiency, energy efficiency, operational efficiency and cost efficiency. To meet the above ever-increasing requirements from market and mobile communication society, next generation access technologies are expected to emerge in the near future.

Work has started in ITU and 3GPP to develop requirements and specifications for new radio systems, as in the Recommendation ITU-R M.2083 “Framework and overall objectives of the future development of IMT for 2020 and beyond”, as well as 3GPP SA1 study item New Services and Markets Technology Enablers (SMARTER) and SA2 study item Architecture for the new RAT (NR) System (also referred to as 5G new RAT). It is required to identify and develop the technology components needed for successfully standardizing the NR system timely satisfying both the urgent market needs, and the more long-term requirements set forth by the ITU-R IMT-2020 process. In order to achieve this, evolutions of the radio interface as well as radio network architecture have to be considered in the “New Radio Access Technology.”

In the legacy LTE/LTE-A, transmission time interval (TTI) is used in MAC layer as a basic time unit that MAC delivers a MAC PDU to PHY, which is fixed to 1 ms. In other words, HARQ entity delivers a MAC PDU to PHY once per TTI.

Multiple numerologies, i.e., multiple subcarrier spacings, such as 30 kHz, 60 kHz, etc, are being studied for the new radio access technology. multiple time units such as slot and mini-slot are under discussion in multiple subcarrier spacing, where mini-slot is the smallest possible scheduling unit and smaller than a slot or subframe. Although the concept of slot has already been in the legacy LTE/LTE-A, it is fixed to 0.5 ms corresponding to 7 OFDM symbols and transparent to the MAC layer operation. In NR, however, slot or mini-slot may have different durations in time depending on the subcarrier spacing. For example, a slot duration would be 0.5 ms for 30 kHz subcarrier spacing while a slot duration would be 0.25 ms for 50 kHz subcarrier spacing. Furthermore, it is required for MAC layer to operate based on slot and/or mini-slot, i.e., the HARQ entity delivers a MAC PDU to PHY once per slot or mini-slot. Considering that it is up to network decision whether to schedule in unit of subframe, slot, or mini-slot, or which subcarrier spacing is to be used, the time unit used for the MAC layer operation may change dynamically. Although the present invention is described with reference to 1 ms TTI and a TTI length shorter than 1 ms, the present invention can be also applied to a TTI duration longer than 1 ms in the same way as or similar way to the following description.

A short TTI with 7 OFDM symbols and 2 OFDM symbols are introduced as a slot and a mini-slot, respectively, and a short TTI with 1 OFDM symbol is under discussion for a mini-slot. Accordingly, MAC needs to operate based on multiple TTIs.

In order to support multiple numerologies and TTI durations, it needs to configure a numerology/TTI duration for a logical channel.

Numerology would be related to the requirement/characteristics of data transmission, e.g., latency. For example, short numerology will be configured to a radio bearer (RB) for which low latency is required while long numerology will be configured to a RB which is not delay sensitive. Given that the requirement/characteristics of data transmission wouldn't change dynamically, it would be sufficient for a UE/network to configure the numerology once when configuring the RB, and use the configured numerology during the lifetime of the RB. In the present invention, once the numerology is associated with the RB, it is not changed until the RB is released.

Assuming that numerology/TTI duration is configured per RB, there is a question on how many numerology/TTI durations can be configured for a RB. In order to reduce signaling overhead, the present invention proposes to configure a range of numerology/TTI duration(s) for a RB. For example, minimum numerology/TTI duration and maximum numerology/TTI duration can be signaled for the RB.

In the meanwhile, there are question on whether HARQ retransmission be performed across different numerologies and/or TTI durations and whether HARQ configuration needs to be specific to numerology/TTI duration. In the LTE/LTE-A system, maxHARQ-Tx and maxHARQ-Msg3Tx are configured for a synchronous HARQ procedure. However, an asynchomous HARQ procedure will be used in NR, and the parameters maxHARQ-Tx and maxHARQ-Msg3Tx are not needed anymore. Therefore, no HARQ configuration needs to be configured. In other words, there is no need of HARQ configuration for different numerology/TTI durations.

In the meantime, if multiple numerologies/TTI durations are needed to be configured for a logical channel, one straightforward method is to indicate all possible numerologies/TTI durations for the logical channel. For a signaling overhead reduction, it was proposed to indicate the maximum numerology/TTI duration for the logical channel. It means that all numerologies/TTI durations less than the maximum numerology/TTI duration can be applied to the logical channel. However, in this case, there is no way to restrict some specific numerology/TTI durations to a specific logical channel. For example, the network may want to allow small TTI duration(s) to logical channels for URLLC service while not allowing those TTI durations for logical channels for eMBB services. Therefore, a new mechanism is needed to exclude some specific numerology that cannot be used for the logical channel. To this end, a minimum numerology/TTI duration may be configured for a logical channel in the present invention.

As mentioned before, there are several DRX timers used in the LTE/LTE-A system. DRX timers currently used in the LTE/LTE-A system are defined either in number of subframes (mac-ContentionResolutionTimer, DRX Cycle, drxShortCycleTimer, HARQ RTT Timer, UL HARQ RTT Timer) or in number of PDCCH-subframes of 1 ms length (onDurationTimer, drx-InactivityTimer, drx-RetransmissionTimer, drx-ULRetransmission Timer). The following DRX timers used in the LTE/LTE-A system are defined in the document 3GPP TS 36.321.

Active Time: Time related to DRX operation, during which the MAC entity monitors the PDCCH. Active Time refers to other timers i.e. is the result of other timer(s) running.

mac-ContentionResolutionTimer: Specifies the number of consecutive subframe(s) during which the MAC entity shall monitor the PDCCH after Msg3 is transmitted. mac-ContentionResolutionTimer refers to subframes.

DRX Cycle: Specifies the periodic repetition of the On Duration followed by a possible period of inactivity. DRX Cycle refers to subframes.

drx-InactivityTimer: Specifies the number of consecutive PDCCH-subframe(s) after the subframe in which a PDCCH indicates an initial UL, DL or SL user data transmission for this MAC entity. drx-InactivityTimer refers to PDCCH subframes.

drx-RetransmissionTimer: Specifies the maximum number of consecutive PDCCH-subframe(s) until a DL retransmission is received. drx-RetransmissionTimer refers to PDCCH subframes.

drx-ULRetransmissionTimer: Specifies the maximum number of consecutive PDCCH-subframe(s) until a grant for UL retransmission is received. drx-ULRetransmission Timer refers to PDCCH subframes.

drxShortCycleTimer: Specifies the number of consecutive subframe(s) the MAC entity shall follow the Short DRX cycle. drxShortCycleTimer refers to subframes.

drxStartOffset: Specifies the subframe where the DRX Cycle starts. drxStartOffset refers to subframes.

HARQ RTT Timer: This parameter specifies the minimum amount of subframe(s) before a DL HARQ retransmission is expected by the MAC entity. HARQ RTT Timer refers to subframes.

UL HARQ RTT Timer: This parameter specifies the minimum amount of subframe(s) before a UL HARQ retransmission grant is expected by the MAC entity. UL HARQ RTT Timer refers to subframes.

onDurationTimer: Specifies the number of consecutive PDCCH-subframe(s) at the beginning of a DRX Cycle. onDurationTimer refers to PDCCH subframes.

They are summarized in the following table. Table 2 shows DRX timers in MAC.

TABLE 2

| Timer Type | Value in number of | Timers |
|---|---|---|
| Type 1 | PDCCH-subframe | onDurationTimer |
| | | drx-InactivityTimer |
| | | drx-RetransmissionTimer |
| | | drx-ULRetransmissionTimer |
| Type 2 | subframe | HARQ RTT Timer |
| | | UL HARQ RTT Timer |
| | | ongDRX-CycleStartOffset |
| | | shortDRX-Cycle |
| Type 3 | shortDRX-Cycle | drxShortCycleTimer |

In the LTE/LTE-A system, PDCCH-subframe (psf) refers to a subframe with PDCCH. Although PDCCH are spread within or over the subframe(s) when multiple numerologies/TTI durations are used, PDCCH-subframe can still refer to a subframe with PDCCH.

As for Type 1 DRX timers, a UE monitors a PDCCH in each PDCCH-subframe if a corresponding DRX timer (i.e. counter) is running, i.e., if the corresponding DRX timer does not reach a maximum value for the corresponding DRX timer, while increasing the corresponding DRX timer by one every PDCCH reception opportunity.

The units for counting DRX timers used in the LTE/LTE-A have been defined based on the assumption that the TTI duration is fixed to 1 ms subframe. If multiple numerology or TTI durations are configured, there could be more than one opportunities per PDCCH-subframe. For example, if a UE is configured with 5 ms TTI duration, there are two scheduling opportunities (i.e. PDCCH reception opportunities) per PDCCH-subframe for the UE. In other words, if multiple numerology/TTI durations are configured, or if a TTI duration different from 1 ms is configured, a different number of PDCCH opportunities can be configured per PDCCH-subframe, and the number of PDCCH opportunities per PDCCH-subframe depends on the TTI duration configured at the UE. In this case, there is an issue on how to calculate the Type 1 DRX timers for different numerology/TTI durations.

The intention of setting the DRX timers in number of PDCCH subframes is to offer a specific number of scheduling opportunities, i.e., number of PDCCHs. Therefore, there could be two approaches in calculating the Type 1 DRX timers as follows.

Option 1. Count the number of PDCCH-subframes regardless of numerology/TTI durations.

Option 2. Count the number of PDCCH opportunities by considering numerology/TTI duration.

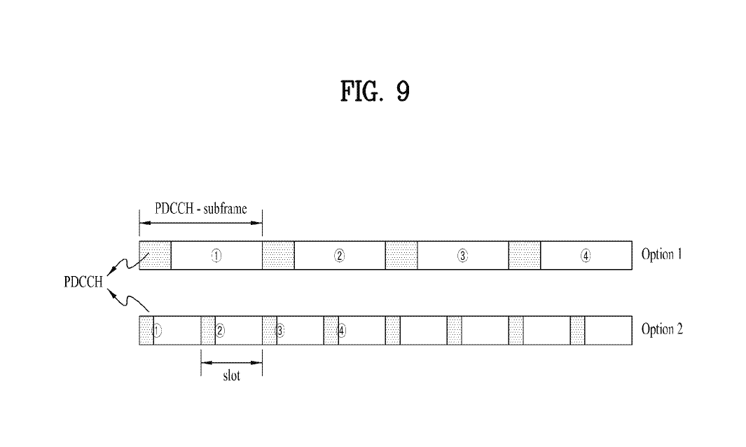

FIG. 9 illustrates methods for counting DRX time according to the present invention. In the examples of FIG. 9, it is assumed that DRX timer is set to 4 psfs, and scheduling with 1 slot of 0.5 ms TTI duration is used.

In Option 1, a DRX timer (i.e. counter) increases by only one in a PDCCH subframe. Referring to FIG. 9, drx-ULRetransmissionTimer counts 4 PDCCH subframes according to Option 1.

In Option 2, a DRX timer (i.e. counter) increases by more than one in a PDCCH subframe. Referring to FIG. 9, drx-ULRetransmissionTimer counts 4 slots, i.e., 2 PDCCH subframes according to Option 2.

In Option 1, the UE will have more scheduling opportunities during the same Active Time compared to Option 2.

If the intention of short TTI is to offer more scheduling chances, Option 1 seems to be acceptable. However, since the main intention of short TTI is to reduce latency in scheduling, it would make sense to offer the same scheduling opportunity per configured TTI by Option 2.

A UE may be configured with multiple TTI durations or a TTI duration different from 1 ms TTI duration. In this case, the UE may configure more than one PDCCH reception opportunities per PDCCH subframe. The UE monitors a PDCCH in each PDCCH reception opportunities if a counter (e.g. Type 1 DRX timer) does not reach a maximum value for the counter. The UE increases the counter by one every PDCCH reception opportunities as time passes. The maximum value for the counter is informed to the UE by using DRX configuration information. Since the counter increases per PDCCH reception opportunity, the maximum value is given in number of PDCCH reception opportunities. The UE stops the counter if the counter reaches the maximum value for the counter. If there is no DRX timer running associated with Active Time, then the UE goes into DRX state. If there is any other DRX timer running associated with Active Time, the UE keeps monitoring PDCCH during Active Time.

In the meantime, among Type 2 DRX timers, UL HARQ RTT Timer and HARQ RTT Timer is to allow UE not to monitor the PDCCH by considering the processing time in network side, i.e., not TTI duration.

Given that processing time reduction and TTI reduction are separate issue, it can be considered that these timers can still count the same number of subframes as in the LTE/LTE-A system regardless of numerology/TTI duration. On the other hand, it would be reasonable to assume that processing time would also be reduced if short TTI duration is used. Then, these timer may need to count less number of subframes by considering the shortened processing time. Given that processing time reducation is not necessarily linearly dependent to TTI duration reduction, there could be two options:

Option A. Count the number of subframe as in the LTE/LTE-A system.

Option B. Define another value of UL HARQ RTT Timer and HARQ RTT Timer for reduced processing time.

For example, HARQ RTT Timer is set to 8 subframes for FDD in the LTE/LTE-A system. Then, HARQ RTT Timer is still 8 subframes in Option A, while another HARQ RTT Timer value (e.g., 6 subframes) could be defined for reduced processing time in Option B.

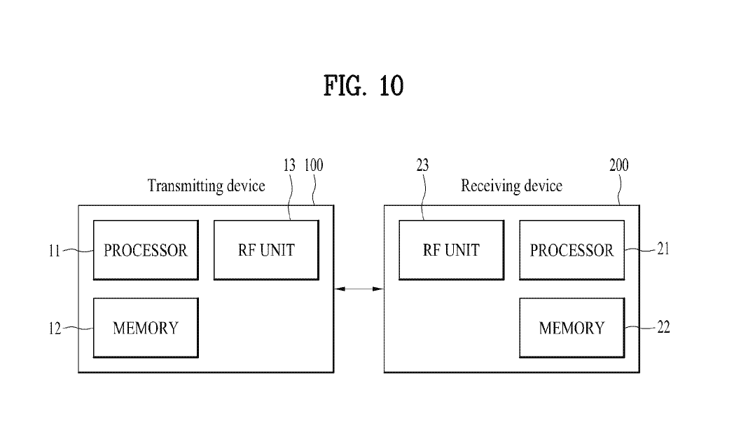

FIG. 10. is a block diagram illustrating elements of a transmitting device 100 and a receiving device 200 for implementing the present invention.

The transmitting device 100 and the receiving device 200 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 100 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 200 is the reverse of the signal processing process of the transmitting device 100. Under control of the processor 21, the RF unit 23 of the receiving device 200 receives radio signals transmitted by the transmitting device 100. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 100 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 200. An RS transmitted through a corresponding antenna defines an antenna from the view point of the receiving device 200 and enables the receiving device 200 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas.

In the embodiments of the present invention, a UE operates as the transmitting device 100 in UL and as the receiving device 200 in DL. In the embodiments of the present invention, an eNB operates as the receiving device 200 in UL and as the transmitting device 100 in DL. Hereinafter, a processor, an RF unit, and a memory included in the UE will be referred to as a UE processor, a UE RF unit, and a UE memory, respectively, and a processor, an RF unit, and a memory included in the eNB will be referred to as an eNB processor, an eNB RF unit, and an eNB memory, respectively.

The UE processor can be configured to operate according to the present invention, or control the UE RF unit to receive or transmit signals according to the present invention. The eNB processor can be configured to operate according to the present invention, or control the eNB RF unit to receive or transmit signals according to the present invention.

The eNB processor may control the eNB RF unit to transmit configuration information for TTI duration(s) to a UE according to the present invention. The eNB processor may perform scheduling using the TTI duration(s) configured to the UE, or transmit/receive signals using the TTI duration(s) configured to the UE, according to the present invention. The UE RF unit may receive the configuration information for TTI duration(s) for the UE. The UE processor may configure TTIs using the TTI duration(s) or operate using the TTI duration(s), according to the present invention. The UE processor may control the UE RF unit to receive or transit using the TTI duration(s), according to the present invention.

For example, in the present invention, the UE may monitor a PDCCH in each PDCCH reception opportunity if a counter does not reach a maximum value for the counter, and increases the counter by one every PDCCH reception opportunity. In the present invention, the UE processor may configure multiple PDCCH reception opportunities if the UE is configured with a TTI duration shorter than the duration of a subframe (i.e. 1 ms). The UE processor increases the counter by more than one in a PDCCH subframe if the UE is configured with a TTI duration shorter than the length (1 ms) of a subframe. In the present invention, the UE processor may configure one PDCCH reception opportunity in a time period spanning multiple subframes if the UE is configured with a TTI duration longer than the duration of a subframe (i.e. 1 ms). The UE processor increases the counter by one over multiple subframes if the UE is configured with a TTI duration longer than the length (1 ms) of a subframe. In other words, in the present invention, the number of multiple PDCCH reception opportunities configured per PDCCH is depending on a TTI duration configured at the UE. The counter may be a drx retransmission timer (drx-RetransmissionTimer) or a drx UL retransmission timer (drx-ULRetransmissionTimer). The UE RF unit may receive configuration information (e.g. DRX configuration information) indicating the maximum value for the counter. The UE processor may configure or operate the counter based on the received configuration information. The maximum value may be a value in number of PDCCH reception opportunities.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

The embodiments of the present invention are applicable to a network node (e.g., BS), a UE, or other devices in a wireless communication system.

what is claimed is:

1. A method for receiving, by a user equipment (UE), downlink signals in a wireless communication system, the method comprising:
configuring, by the UE, multiple physical downlink control channel (PDCCH) reception opportunities per PDCCH subframe;
monitoring, by the UE, a PDCCH in each PDCCH reception opportunity if a counter does not reach a maximum value for the counter; and
increasing, by the UE, the counter by one every PDCCH reception opportunity,
wherein the counter increases by more than one in a PDCCH subframe.

2. The method according to claim 1,
wherein the number of multiple PDCCH reception opportunities configured per PDCCH subframe is depending on a transmission time interval (TTI) duration configured at the UE.

3. The method according to claim 1,
wherein the counter is a drx retransmission timer, or a drx UL retransmission timer.

4. The method according to claim 1,
receiving, by the UE, information indicating the maximum value for the counter.

5. The method according to claim 4,
wherein the maximum value is a value in number of PDCCH reception opportunities.

6. A user equipment (UE) for receiving downlink signals in a wireless communication system, the UE comprising:
a radio frequency (RF) unit; and
a processor configured to control the RF unit, the processor configured to:
configure multiple physical downlink control channel (PDCCH) reception opportunities per PDCCH subframe;
monitor a PDCCH in each PDCCH reception opportunity if a counter does not reach a maximum value for the counter; and
increase the counter by one every PDCCH reception opportunity,
wherein the processor is configured to increase the counter by more than one in a PDCCH subframe.

7. The UE according to claim 6,
wherein the number of multiple PDCCH reception opportunities configured per PDCCH subframe is depending on a transmission time interval (TTI) duration configured at the UE.

8. The UE according to claim 6,
wherein the counter is a drx retransmission timer, or a drx UL retransmission timer.

9. The UE according to claim 6,
wherein the processor is configured to control the RF unit to receive information indicating the maximum value for the counter.

10. The UE according to claim 9,
wherein the maximum value is a value in number of PDCCH reception opportunities.
